(19) United States
(12) Patent Application Publication
(10) Pub. No.: US 2002/0152985 A1
(43) Pub. Date: Oct. 24, 2002

(54) System, apparatus including on-board diagnostics, and methods for improving operating efficiency and durability of compression ignition engines

(76) Inventor: Peter U. Wolff, Winter Haven, FL (US)

Correspondence Address: JEFFREY S. WHITTLE, ESQUIRE, ALLEN, DYER, DOPPELT, MILBRATH & GILCHRIST, P.A., P.O. Box 3791, Orlando, FL, 32802-3791, US

(21) Appl. No.: 10/044,700

(22) Filed: Jan. 11, 2002

Related U.S. Application Data
(60) Provisional application No. 60/285,199, filed on Apr. 20, 2001.

(51) Int. Cl. F02B 5/00

(52) U.S. Cl. 123/305; 123/479; 123/494

(57) ABSTRACT

A system, apparatus including on-board diagnostics, and methods are provided for sensing the effects of differing fuel quality in charge-by-charge, and cylinder-by-cylinder variation, and using a sensor and feedback to adjust the fueling to reduce the variation between charges in each cylinder to improve performance, reduce emissions, and increasing the operative life of a compression ignition engine.

### RELATED INVENTION

This invention claims the benefit of provisional application titled, System, Apparatus Including On-Board Diagnostics And Methods For Improving Operating Efficiency And Durability Of Compression Ignition Engines, Serial No. 60/285,199 filed Apr. 20, 2001, which is incorporated herein in its entirety.

### FIELD OF THE INVENTION

The present invention relates to the field of compression ignition engines and, more particularly, to fuel injection in compression engines.

### BACKGROUND OF THE INVENTION

Ever more stringent regulations on automobile emissions such as the Federal Tier II standards, the California Ultra-Low Emissions Vehicle (ULEV) standards, and the proposed Low Emissions Vehicle II (LEV II) standards are requiring greater and greater reductions in nitrous oxides NOₓ) and other air pollutants. As explained herein, however, changing fuel composition in order to meet more stringent emission reduction requirements can adversely affect an engine's performance and increase wear on the engine over its operational life.

Operational efficiency of a compression engine depends critically on the rate and timing of the fuel injection event (i.e., the injection of fuel into the engine's combustion chambers). Injection rate and timing are functions of engine speed, load, and the conditions under which the engine is operated. Injection rate and timing also are affected by the composition of the fuel used to power the engine. Accordingly, altering fuel composition so as to reduce engine emissions will affect injection rate and timing. For example, reducing NOₓ emissions retards fuel injection timing, whereas the operating efficiency of the engine is enhanced by advanced timing of the injection event.

Changes in fuel composition not only affect the engine's operational efficiency, but, as already alluded to above, the engine's maintainability as well. Engine durability depends on sufficient lubrication of the mechanical components of the engine's fuel injection equipment (FIE), which for increased efficiency's sake often have strict tolerances (e.g., the efficiency of a nozzle-tip fuel injector is positively correlated to the smallness of the diameter of the spray hole). Reducing the sulfur content of the fuel used in the engine reduces NOₓ emissions, but increases wear on the FIE by reducing the lubricity of the fuel.

To reduce engine emissions, a number of alternatives to diesel fuel have been suggested such as methanol, ethanol, CNG, LPG, and LNG. But while reducing engine emissions, these fuel alternatives tend to be uneconomical as compared to diesel fuel owing to their more limited availability and differing physical properties requiring, for example, different storage constraints. Thus, the limited availability of such alternative fuels makes them more costly, while their wider use would necessitate substantial investments in new storage infrastructure adding further to their price. Moreover, with the exception of ethanol, these alternative fuels are, like diesel, fossil fuels (most ethanol is derived from natural gas). Hence, the world's total reserves for these alternative fuels are likewise limited.

Biodiesel fuel is one alternative that appears to offer significant promise. Biodiesel is made from transesterified vegetable oils, but its chemical and physical properties are similar to fossil diesel fuels so that it can be used in compression ignition engines. Indeed, while offering substantial reduction in CO₂, many of the properties of biodiesel fuel are similar or superior to diesel fuel. The cetane number (i.e., content of C₁₆H₃₄) of biodiesel fuel, for example, is even higher than that of premium diesel fuel. Another advantage is that biodiesel fuel has a heating value that is comparable to diesel fuel and lower than that of other alternative fuels, thus offering advantages with respect to its storage and obviating the need for changes infrastructure to accommodate its wider distribution and use. Biodiesel also produces fewer hydrocarbons and particulate emissions.

Biodiesel fuel, however, poses the same problems inherent in other alternative fuels in terms of engine efficiency and maintainability. More specifically, these problems stem from the effects described above that fuel composition has on a fuel's compressibility (perhaps best measured by the fuel's bulk modulus), which affects the rate and timing of the engine's injection event. For example, if biodiesel fuel is used in an engine designed for use with diesel fuel, the different compressibility of the biodiesel fuel will affect the rate and timing of the engine's injection event, adversely affecting the engine's performance. Owing to the different compressibility of the biodiesel fuel, the engine designed for diesel fuel use responds as though the injection timing has been advanced, thus increasing NOₓ formation. If the situation is reversed, the engine will act as if fuel injection timing has been retarded, and an increase in particulate and HC emissions will result. In both instances, because the engine is optimally timed for one particular fuel composition, the use of a different fuel composition will alter the fuel injection timing thereby resulting in suboptimal engine performance. Variability in fuel composition exacerbates the effect disclosed in the technical literature that engine type and size have on the operational characteristics (steady and transient) of the fuel injection event. Moreover, even for the same type of fuel, there frequently is variability among different samples owing to production and other factors broadly described as supplier variability.

These problems are inherent not only in biodiesel but in other proposed alternative fuels such as so-called boutique fuels, DME and diesel fuel with emulsified H2O as well as diesel fuel itself.

Optimal fuel injection requires a compromise between thermodynamic efficiency and acceptable engine emissions. But without any means to factor-out the variability of compressibility and control precisely injection timing there is no means to ensure engine efficiency or the reduction of emissions over the life of the engine. Current engine technology is focused on improving engine performance and reducing fuel emissions by increasing injection pressures and controlling injection timing so as to rate-shape the heat of combustion within an engine's combustion chamber. Conventionally, only one combustion cylinder is monitored and controlled, with the others being passively controlled. A solenoid is commonly employed to act on the fuel injection mechanism. Examples include unit injectors, hydraulically controlled injectors, solenoid-controlled pump-line injectors, common rail injectors, and common passage fuel injectors all aimed at increasing injection pressures (usually 20,000 PSI/1400 Bar and higher).

Conventional fuel injection systems are open-loop controlled in the sense that there is no sensor to measure the attributes of actual fuel injection being accomplished. For example, with respect to an injector employing a needle valve, there is no sensor to measure the needle lift. Likewise, there is no sensor to measure pressure at the tip of the injector. The open-loop control systems similarly do not provide a feedback signal corresponding to injection timing independent of the controlling solenoid or other actuation means. As described above, however, fuel compression can alter the timing of the injection pulse. Therefore, without a sensor to measure the actual pulse (e.g., needle lift or nozzle tip pressure), the injection event can not be controlled in a way that determines and adjusts for deviations from the desired injection timing owing to variations in the compressibility of the particular fuel being used to power the engine.

It is also important to note that modern compression ignition engines rely for optimum performance on algorithms that electronically control fuel injection timing. In terms of the electrical, signaling-based aspects of fuel injection, the control algorithms employed are based on the assumption that fuel composition is constant or within a fairly narrow tolerance band. If different additives or fuel blends are utilized, the compressibility, or rate of compression, of the fuel is altered with the result that the fuel injection timing is not that intended. But because, as described above, conventional open-loop control systems do not control for variations in fuel composition, there is, accordingly, no means to deal with deviations from the implicit assumption on which these control algorithms are based, namely that the fuel composition is fairly uniform throughout the operative life of the engine.

In addition to altering the fuel's compressibility, differing fuel compositions also can affect frictional forces between the engine's moving components. This, in turn, can also effect the injection timing so that actual fuel injection deviates from the optimum intended in accordance with the specific control algorithm. Moreover, it can increase wear on the engine, reducing the operational life of the engine. Over the lifetime of an engine, each tank of fuel used to power the engine may be different in terms of fuel compressibility and lubricity. Thus, a challenge to maintaining optimum engine performance over the life of the engine is to control the injection timing by adjusting for the differences in fuel composition and quality that are certain to occur over the life of the engine.

Moreover, other fuel injection timing problems can arise that are not necessarily related to varied fuel composition. These problems, too, stem from the lack of an effective means to monitor and correct for unwanted deviations from the desired fuel injection timing during operation of the engine. One such problem arises, for example, if the solenoid used to control fuel injection is in magnetic field saturation. Even if the solenoid is working, the nozzle or other mechanical components of a fuel injector may become jammed or non-operative, thereby giving a false signal that a proper injection event has occurred. Should the injector tip be damaged as a result of dirt particles or water so that the injector valve does not seal, unwanted fuel under high pressure can be delivered to the cylinder resulting in poor engine performance. If a malfunction causes an injector valve to stick open, fuel could dump continuously into the cylinder with damaging results.

There is, therefore, a need for a way to detect and control for deviations in the actual fuel injection timing from that desired for optimum engine performance. There is a further need to detect for potentially damaging malfunctions in fuel injection timing of an engine as well as for some way to detect and control for deviations of the actual fuel injection timing from that desired for optimum engine performance.

### SUMMARY OF THE INVENTION

With the foregoing in mind, the present invention advantageously provides a closed-loop system, apparatus including on-board diagnostics, and methods for reducing the effects of variations in fuel composition within a compression ignition engine over the operational life of the engine. The system, apparatus and methods control for variations in fuel injection timing resulting from variability in the compressibility and lubricity of fuels used to power the engine. Control of variations in compressibility and lubricity provides distinct advantages including enhanced operational performance of the engine regardless of the composition of a particular fuel used to power the engine at any given time and reduced wear on the engine over the operative life of the engine.

The closed-loop system of the claimed invention measures the fuel injection event by, for example, measuring the needle lift of needle valve injector, and provides a feedback signal that permits control of shot-by-shot variations in fuel injection. Shot-by-shot control is a way for controlling the fuel injection charge between injection events on a single fuel injector: as between successive injection events, the initiation, the duration, and the rate of injection can each be altered before the next injection event occurs. With shot-by-shot control of the injection event, cylinder-by-cylinder variations can also be reduced or eliminated on the engine, thereby allowing for more uniformed and controlled combustion such that the engine's overall efficiency and fuel economy is improved while fuel emissions are reduced or eliminated. Cylinder-by-cylinder variation is a way of factoring out the differences between all cylinders of a multi-cylinder engine so as to permit all cylinders to perform substantially equally even though the operating conditions between individual cylinders may be different. This contrasts sharply with conventional systems, which as noted above merely control or monitor only one cylinder and apply control passively to the remaining ones.

As described in detail below, the shot-by-shot, cylinder-by-cylinder monitoring and control provided by the present invention allows fuel injection timing of the engine to be adjusted so as to compensate for the effects of compressibility of any fuels used during the life of the engine. The present invention also permits monitoring and control for deviations from optimal injection timing stemming from mechanical wear of the FIE. A further advantage is that the system can be incorporated into newly designed engines or adapted for use with existing ones. The system further is operable independently or within the framework of an engine control unit (ECU). The system thus permits ECU monitoring and control for variability in fuel compressibility and lubricity. It further permits the ECU to account for mechanical wear on the FIE by altering fuel injection timing so as to maintain the fuel injection event within a desired set of parameters and, as further described below, provide an onboard diagnostic signal when the event can not be brought within the desired parameters.

Among the advantages of the present invention is the ability to provide optimal fuel injection timing in the presence of greater variability in fuel compressibility and lubricity while simultaneously allowing for increased strictness of mechanical tolerances of the FIE. Thus the system both reduces or eliminates the stress of stricter tolerances on the FIE while providing for lessened fuel emissions. The system further provides for the monitoring and control of the initiation and termination of the fuel injection event. It provides for the monitoring and control of the rate of injection. It takes into account and accommodates changes in fuel viscosity, compressibility, and lubricity. It accounts for and accommodates changes in injection lag (i.e., sound velocity) and variations in injection timing owing to wear on FIE components due to age and adverse operating conditions. It provides a feedback signal to adjust the duration of fuel injection. It provides a feedback signal to the ECU corresponding to the amount of fuel injected. And the system provides, preferably as part of an onboard diagnostic system, an onboard diagnostic indicator to indicate problems with fuel injection and damage to the FIE.

The system according to the present invention includes a fuel injection controller, a fuel injection sensor, and an engine controller. The engine controller further includes an actual fuel pulse determiner, a fuel pulse comparator, a fuel pulse compensator, and a command signaler. The fuel injection controller, in response to command signals supplied by the command signaler, controls the release of fuel from a fuel supply line to a fuel injector that, in turn, injects fuel into at least one combustion chamber of a compression ignition engine. The fuel injection sensor monitors injection events by sensing when the fuel injector is actuated (i.e., in a condition to inject fuel into the at least one combustion chamber). The fuel injection sensor then generates a sensed signal responsive to the fuel injector's being actuated.

The sensed signal generated by the fuel injection sensor is conveyed to the fuel pulse determiner, which, in response thereto, determines an actual fuel pulse. The actual fuel pulse generally corresponds to the duration of the time interval that the fuel injector is actuated, the time interval being at least partially determined by the compressibility and lubricity of fuel supplied through the fuel supply line. The fuel pulse comparator responds to the fuel pulse determiner by comparing the actual fuel pulse to a preselected, desired fuel pulse, where the desired fuel pulse corresponds to a desired time interval that the fuel injector is actuated. In response to the comparison, the fuel pulse compensator computes a fuel pulse compensation factor defined as the difference obtained by subtracting the actual fuel pulse from the desired fuel pulse. The command signaler responds to the fuel pulse compensator by generating command signal based on the desired fuel pulse and the compensation factor. Specifically, the command signaler conveys a command signal that causes the injection controller to controllably release fuel so that subsequent actual fuel pulses more closely correspond to the preselected, desired fuel pulse.

Thus, the system according to the present invention provides closed-loop control of fuel injection timing that factors-in and adjusts for variations in the compressibility and lubricity of fuels of different composition used to power the engine More specifically, the system provides a closed-loop system that preferably includes a fuel injection sensor for use in generating a sensor-determined feed-back signal. Shot-by-shot per individual cylinder, then, the sensor-generated signal corresponds to an actual fuel injection event (i.e., fuel pulse) from which an appropriate adjustment is made so that the engine controller sends a subsequent injection command signal to the injection controller in order to achieve the desired fuel injection.

Preferably, the system also includes an onboard diagnostic indicator that indicates when the actual fuel pulse can not be brought closer to that desired so as to achieve optimum fuel injection timing. The onboard diagnostic indicator in communication with the fuel injection sensor, moreover, can also indicate if the fuel injector malfunctions. The user is then alerted to the need to service the fuel injection system before extensive damage to the engine occurs.

The actual fuel pulse determiner, fuel pulse comparator, fuel pulse compensator, command signaler, and fuel injection sensor define a distinct apparatus that can be used either in conjunction with an existing engine control unit or as an independent device to control for variations in a compression ignition engine's fuel injection timing resulting from variability in the compressibility and lubricity of fuels used to power the engine.

A distinct aspect of the claimed invention is a program stored in a memory unit and adapted to be used by a processor in conjunction with a fuel injector and a fuel injection controller to control for variations in fuel injection timing in a compression ignition engine. The program, specifically, includes means to compute an actual fuel pulse in response to the sensed fuel injection signal. The program further provides means to compare the actual fuel pulse to a preselected desired fuel pulse. The program also includes means to compute a fuel pulse compensation factor. And the program includes means to generate a command signal that is conveyed to a fuel injection controller in communication with the fuel injector. The command signal generated is based on the desired fuel pulse and compensation factor so as to generate a signal that signals the injection controller to controllably release fuel for a pulse of duration that more closely correspond to the desired fuel pulse. The program, moreover, is preferably adapted to individually and independently control for variations in fuel injection timing in each cylinder of a multi-cylinder engine.

The present invention further provides a method for controlling variations in fuel injection timing resulting from variability in the compressibility and lubricity of fuel used to power a compression ignition engine. The method includes sensing the actual rate at which fuel is injected into at least one cylinder of the engine. The actual rate of fuel injection sensed can be compared with a fuel injection parameter indicating the desired rate of fuel injection. Based on the comparison, the rate of fuel injection can be altered to thereby inject fuel at the desired rate.

A method for controlling variations in fuel injection timing resulting from variability in the compressibility and lubricity of fuels used to power an ignition compression engine according to the present invention includes generating a first command signal, Cᵢ, and actuating a first fuel injection at a first fuel injection rate into a combustion chamber of the engine in response to the first command signal. A first injection value, Aᵢ, is then determined, the value having a correlation with the first fuel injection rate. The first injection value, Aᵢ, is compared to a preselected injection parameter, Dᵢ, corresponding to a desired rate of fuel injection into the combustion chamber, and a second command signal, Cᵢ₊₁, is generated in response to thereto. Based on the comparison, a second fuel injection is actuated at a second fuel injection rate into the combustion chamber in response to the second command signal, Cᵢ₊₁, yielding a second injection value, Aᵢ₊₁. The second injection value is selected to have a correlation with the second fuel injection rate such that the absolute value of the difference between the second injection value and the preselected injection parameter, |Aᵢ₊₁−Dᵢ|, is less than or equal to the absolute value of the first injection value and the desired rate, |Aᵢ−Dᵢ|, so that |Aᵢ₊₁−Dᵢ|≦|A₁−Dᵢ|. Accordingly, if fuel injection timing initially deviates from a desired rate, then subsequent injections will be controlled so as to correspond more closely to the desired rate.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a schematic view of a system for use with a compression ignition engine to control for variations in the engine's fuel injection timing according to the present invention;

FIG. 2 is a schematic view of a first embodiment of an apparatus to control for variations in a compression ignition engine's fuel injection timing according to the present invention; and

FIG. 3 is a schematic view of a second embodiment of an apparatus to control for variations in the engine's fuel injection timing according to the present invention.

### DETAILED DESCRIPTION OF THE PREFERRED EMBODIMENTS

The present invention will now be described more fully hereinafter with reference to the accompanying drawings which illustrate preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, the prime notation, if used, indicates similar elements in alternative embodiments.

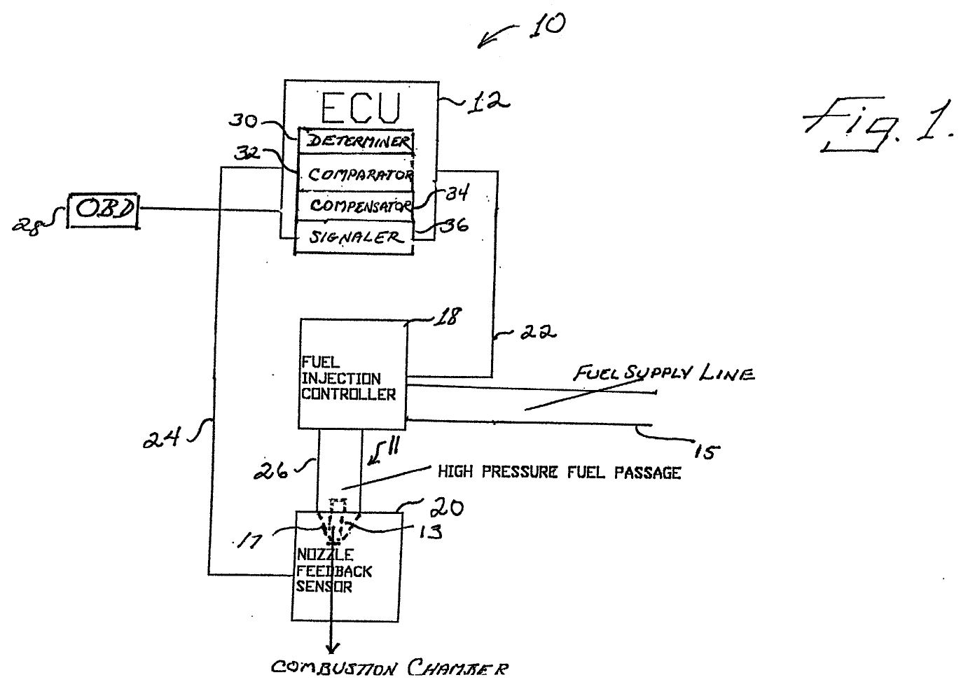

FIG. 1 provides a schematic illustration of a cylinder-by-cylinder, closed-loop system 10 for use with a compression ignition engine to control on a shot-by-shot (or charge-by-charge) basis for variations in the engine's fuel injection timing, these variations resulting from variability in the compressibility and lubricity of fuels used to power the engine over the operative lifetime of the engine. (Perhaps the best measure of a fuel's compressibility is the bulk modulus of the fuel.) The system 10 includes a fuel injection controller 18 that, in response to a command signal, controls the release of fuel from a fuel supply line 15. As will be readily appreciated by those skilled in the art, controlled fuel release can be accomplished, for example, using a solenoid that acts upon a fuel injecting mechanism. More specifically, the solenoid comprises a coil and a metal core free to slide along the coil axis under the influence of a magnetic field induced by a changing electrical current, thereby providing a type of switch responsive to an electrically based signal. Specific examples include unit injectors, hydraulically controlled unit injectors, solenoid controlled pump-line injectors, common rail injection, or common passage fuel injection, each of which shares the aspects of increased injection pressures (e.g., 20,000 PSI/1200 Bar or higher) actuation by an electrically based signal.

The system 10 also includes a fuel injector 11 positioned to receive the released fuel and inject the fuel into a combustion chamber of the engine. Preferably, the fuel injector 11 includes a high pressure fuel passage 26 and nozzle tip 17. The fuel injector preferably also includes a valve 13 positioned at or near the nozzle tip 17, the valve 13 being adapted to open in response to a pressure pulse resulting when the released fuel passes through the high-pressure passage and reaches the nozzle tip 17. For example, the fuel injector valve can open as a result of fluid pressure generated by the fuel released from the fuel supply line 15 in response to the fuel injection controller 18. In general, then, the cooperative action of the fuel injector controller 18 and fuel injection mechanism permit fuel to be injected at discrete time intervals into each combustion cylinder of the engine.

Conventional fuel injection control systems are open-loop in the sense that there is no technique or device with such systems for detecting whether or not fuel is being injected with the intended timing. More specifically, conventional systems can not ascertain whether the actual injection event (e.g., fuel pulse or time duration during which fuel is being injected under pressure into a combustion chamber) is occurring as intended. Conventional systems rely on an algorithm-based series of command signals intended to cause intermitted fuel pulses of a desired duration. The algorithms are based, however, on the assumption that the compressibility of injected fuels are constant or fairly uniform. When the compressibility of a fuel varies, as will be the case for differing fuel compositions, the actual fuel pulse can differ from that intended. In order to control for such variation, therefore, the system 10 according to the present invention further includes a fuel injection sensor 20 positioned to sense the actual fuel injection event (i.e., actual fuel pulse) that occurs in response to a command signal.

Preferably, the fuel injection sensor 20 is positioned adjacent the fuel injector 11, as illustrated in FIG. 1. For a fuel injector 11 that includes a valve 13 positioned at the nozzle tip 17 that opens to inject fuel into the combustion chamber, as described above, the fuel injection sensor 20 is adapted to sense when the valve 13 is in an open position and generate the sensed signal in response to the sensed open position. If, for example, the fuel injector 11 includes an injection nozzle having a needle valve, the fuel injection sensor 20 can be positioned to sense movement of the needle. Alternatively, the fuel injection sensor 20 can be positioned to sense fluid pressure at the nozzle tip 17 of the fuel injector 11. The fuel injection sensor 20, specifically, can include a pressure transducer positioned adjacent the fuel injector or a piezoelectric sensor positioned adjacent the fuel injector 11. In any event, the fuel injection sensor 20 provides a sensed signal that correlates to the true fuel injection event or actual fuel pulse (e.g., the actual time duration that the fuel injector valve is in an open position and injecting fuel into the combustion chamber). As described below, the system 10 uses this sensed signal to determine the actual fuel pulse, Aᵢ, which can then be compared to a preselected parameter corresponding to the desired fuel pulse in order to control deviations of the actual fuel pulse from that desired.

The system 10 further includes an engine control unit, defining an engine controller 12. The engine controller 12 controls the functioning of the engine. According to the present invention, the engine controller 12 of the system 10 is positioned to be in communication with both the fuel injection controller 18 and the fuel injection sensor 20. The engine controller 12 includes an actual fuel pulse determiner 30. The fuel pulse determiner 30 is responsive to the sensed signal generated by the fuel injection sensor 20 described above. On the basis of the sensed signal the fuel injection sensor 20 determines the actual injection event or actual fuel pulse, Aᵢ. The actual fuel pulse is expressly defined herein as the duration of the time interval that the fuel injector 11 is actuated. More specifically, it is the time duration that the valve of the fuel injector is in an open position, the time interval being at least partially determined by the compressibility and lubricity of fuel supplied through the fuel supply line 15.

According to the claimed invention, the engine controller 12 also includes a fuel pulse comparator 32 that is responsive to the actual fuel pulse determiner 30. The fuel pulse comparator 32 compares the actual fuel pulse, Aᵢ, to a preselected desired fuel pulse, Dᵢ, the desired fuel pulse being defined as a desired duration for the fuel injector 11 to be actuated so as to inject fuel into the combustion chamber (e.g., the desired time duration that the valve 13 of the fuel injector 11 is in an open position).

The engine controller 12, according to the claimed invention, further includes a fuel pulse compensator 34 responsive to the fuel pulse comparator 32. The fuel pulse compensator 34 computes a fuel pulse compensation factor, k, the compensation factor being defined as the difference obtained by subtracting the actual fuel pulse from the desired fuel pulse, Dᵢ−Aᵢ. The engine controller 12, moreover, also includes a command signaler 36 responsive to the fuel pulse compensator 34, the fuel pulse compensator 34 being in communication with the fuel injection controller 18. The fuel pulse compensator is adapted to generate the compensation factor so that a subsequent command signal can be adjusted to compensate for deviations of the desired fuel pulse from the actual fuel pulse. Specifically, successive command signals generated by the command signaler incorporate the compensation factor, k, so that each subsequent command signaler signals the injection controller to controllably release fuel for a pulse of duration Cᵢ₊₁=Dᵢ+k such that subsequent actual fuel pulses more closely correspond to the desired fuel pulse.

In operation, the engine controller 12, controls the operation of the engine, including the timing of fuel injection into at least one combustion chamber. Command is exercised by the engine controller 12 sending a control signal, defining the command signal, via a command signal path 22 to the fuel injection controller 18. The fuel injection controller 18 responds by releasing fuel received via the fuel supply line into the fuel passage 26 of the fuel injector 11 to be injected by the fuel injector. Once the fuel reaches the fuel injector nozzle, fuel pressure opens the nozzle thereby injecting fuel into the engine cylinder for a pulse duration of Cᵢ. As the fuel is injected, the fuel injection sensor 20, preferably a nozzle feedback sensor, generates a feedback signal defining a sensed signal. The sensed signal is conveyed via a sensed signal path 24 to the actual fuel pulse determiner 30 which determines the actual fuel pulse. The signal comparator 32 compares the actual fuel pulse with a parameter value, preferably stored in a memory associated with the ECU, representing the desired fuel pulse. Based on the comparison, the fuel pulse compensator computes a fuel pulse compensation factor, k. The command signaler then conveys via a subsequent command signal via the command signal path 22 to effect a subsequent fuel injection into the combustion chamber of the engine for a pulse duration of Cᵢ₊₁. As described above, this compensated fuel pulse more closely corresponds to the desired fuel pulse parameter value so that the adjusted fuel injection timing is closer to that desired for optimum engine performance. This operation, as already noted, is performed charge-by-charge (“shot-by-shot”) and cylinder-by-cylinder; that is, fuel injection timing is controlled for each successive injection event (i.e., fuel pulse) of each cylinder individually and independently.

The system 10 preferably further includes an onboard diagnostic indicator 28 in communication with the engine controller 12 and fuel injection sensor 18 that indicates when the system 10 fails to control for variations in fuel injection timing. For example, if successive command signals fail to bring the actual fuel pulse closer to the desired fuel pulse, the onboard diagnostic indicator 28 indicates the failure to the system user. Moreover, the onboard diagnostic indicator 28 preferably also indicates when the fuel injector 11 becomes inoperative. If, for example, the fuel injector 11 includes a valve 13, then the onboard diagnostic indicator 28 indicates when the valve is unable to be taken out of the open position or otherwise remains inoperably stuck in a closed position. Similarly, the onboard diagnostic indicator 28 can also indicate whenever the nozzle tip 17 of the fuel injector 11 becomes clogged or otherwise damaged (e.g., when the injector fails to properly seal). Accordingly, the onboard diagnostic indicator indicates when fuel is not being injected by the injector 11 or, conversely, is being injected at an undesired rate.

The fuel injector sensor 18 and an onboard diagnostic indicator 28 combine to provide a system 10 with significant advantages over conventional devices that do not sense actual fuel injection. A conventional device employing a solenoid as a feedback, for example, will not accurately depict actual fuel injection if the solenoid is in magnetic field saturation. Even if the solenoid is functioning, the nozzle or other fuel injection component may be jammed or otherwise inoperative. Should an injector tip become damaged as a result of dirt particles or water so that the injector does not properly seal between fuel injections, unwanted fuel under high pressure may be injected into the cylinder resulting in poor engine performance. Similarly, if a malfunction causes the injector valve to stick in an open position, fuel may be injected continuously into the combustion chamber causing damage to the engine. The system 10, according to the present invention, prevents these and other malfunctions from going undetected and damaging the engine in that the fuel injection sensor 18 of the system 10 is able to sense the actual fuel injection event and with the onboard diagnostic indicator 28 alert the user of any such malfunctions that require immediate servicing.

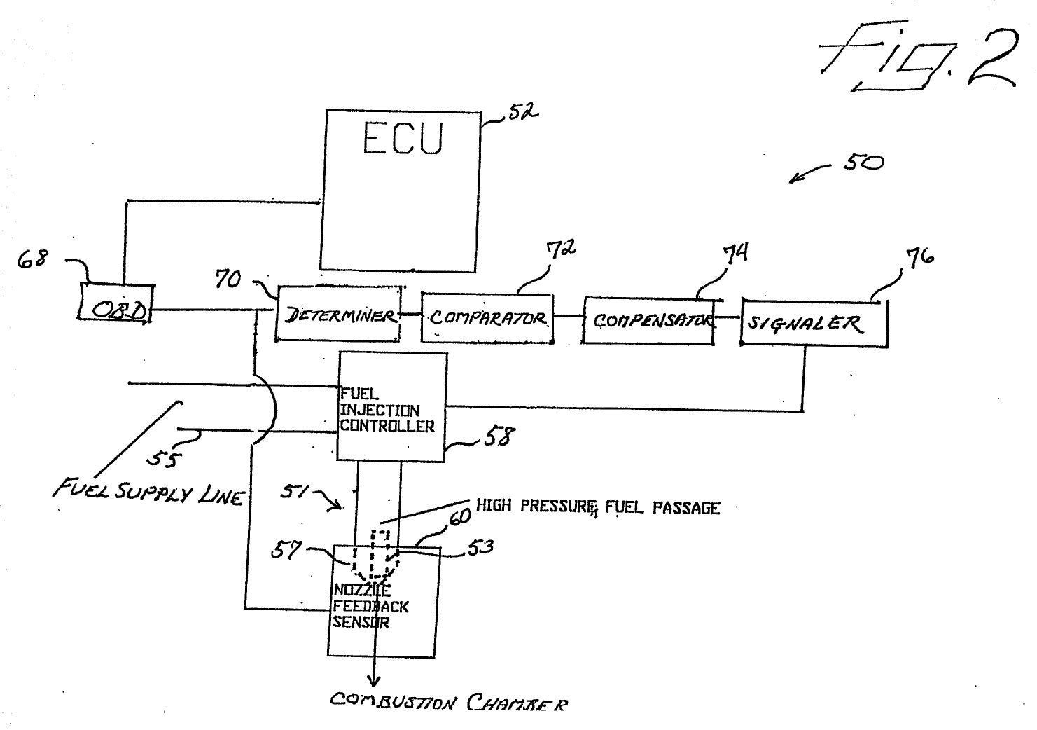

FIG. 2 illustrates an apparatus 50 according to the present invention. The apparatus 50 controls for variations in a compression ignition engine's fuel injection timing resulting from variability in the compressibility and lubricity of fuels used to power the engine. The apparatus 50 can be used independently of an existing engine control unit 52 to control for deviations of actual fuel injection timing from desired fuel injection timing. (As described below, however, an alternative embodiment of the apparatus can be used in conjunction with an existing engine control unit.)

The apparatus 50 includes a fuel injection sensor 60 positioned to sense when a fuel injector 51 is actuated so as to inject fuel into a combustion chamber of the engine. The fuel injector 51 generates a sensed fuel injection signal in response thereto. The fuel injector 51 preferably includes an injection nozzle 57 having a valve 53 such that fuel under pressure is injected into the combustion chamber when the valve 53 is in an open position. The fuel injection sensor 60 is positioned to sense the actuation of the fuel injector 51 and, accordingly, senses when the fuel injector valve 53 is in the open position. More preferably, the fuel injector valve 53 is a needle valve, and the fuel injection sensor 60 senses movement of the needle to determine when the valve is in the open position so that the fuel injector 51 is actuated to inject fuel into the combustion chamber. Alternatively, the fuel injection sensor can sense actuation of the fuel injector 51 by sensing fluid pressure in the fuel injector nozzle 57. The fuel injection sensor can be, for example, a pressure transducer or a piezoelectric sensor positioned adjacent the fuel injector or, more preferably, within the fuel injector.

As further illustrate in FIG. 2, the apparatus also includes an actual fuel pulse determiner 70 responsive to the sensed signal corresponding to an actual fuel injection event (i.e., a fuel pulse). The determiner 70 determines an actual fuel pulse, Aᵢ, based on the sensed signal generated by the fuel injection sensor 60. As described above, the actual fuel pulse, Aᵢ, is defined as the duration of the time interval that the fuel injector is actuated to inject fuel into the combustion chamber, the time interval being at least partially determined by the compressibility and lubricity of the fuel injected.

As also illustrated in FIG. 2, the apparatus 50 additionally includes a fuel pulse comparator 72 that is responsive to the actual fuel pulse determiner 70. The fuel pulse comparator 72 compares the actual fuel pulse, Aᵢ, to a preselected desired fuel pulse, Dᵢ, the desired fuel pulse being defined as a desired duration for the fuel injector to be actuated so as to inject fuel into the combustion chamber. Further, the apparatus includes a fuel pulse compensator 74 that is responsive to the fuel pulse comparator. The fuel pulse compensator computes a fuel pulse compensation factor, k, defined by the difference obtained by subtracting the actual fuel pulse from the desired fuel pulse, Dᵢ−Aᵢ. The apparatus, moreover, includes a command signaler 76 that is responsive to the fuel pulse compensator 74 and that is positioned in communication with a fuel injection controller 58 that is positioned to control fuel injection by the fuel injector 51 in response to a command signal. The command signal is generated by the command signaler 76 and is based on the desired fuel pulse and compensation factor, being a function of each, such that the command signaler signals the injection controller to controllably release fuel for a pulse of duration Cᵢ₊₁=Dᵢ+k, so that subsequent actual fuel pulses more closely correspond to the desired fuel pulse.

The apparatus 50 functions to control for shot-by-shot variations on a cylinder-by-cylinder basis. Accordingly, each successive injection event for each cylinder of a multi-cylinder engine can be individually and independently controlled for variations in fuel injection timing.

Preferably, the apparatus further includes an onboard diagnostic indicator 68 that is positioned in communication with the fuel injection sensor 60 so as to indicate when the apparatus 50 fails to control for variations in fuel injection timing. Specifically, when successive fuel injection pulses commanded by command signals compensated by the compensation factor fail to correspond more closely to the desired fuel pulse, the onboard diagnostic indicator 68 will indicate a control failure has occurred. The onboard diagnostic indicator 68, moreover, preferably indicates when the fuel injector is inoperative and requires repair. More specifically, the onboard diagnostic indicator 68 indicates when the fuel injector 51 remains actuated (e.g., when an injector valve becomes stuck in an open position) or otherwise fails to prevent unwanted fuel injections (e.g. when an injector tip were is damaged so as to prevent sealing with the injector valve). Thus, in contrast to conventional devices, the apparatus 50 can prevent unwanted fuel being injected under high pressure into the combustion chamber. This prevents poor engine performance and possible engine damage in the event of a failure by the system 50 to control fuel injection timing.

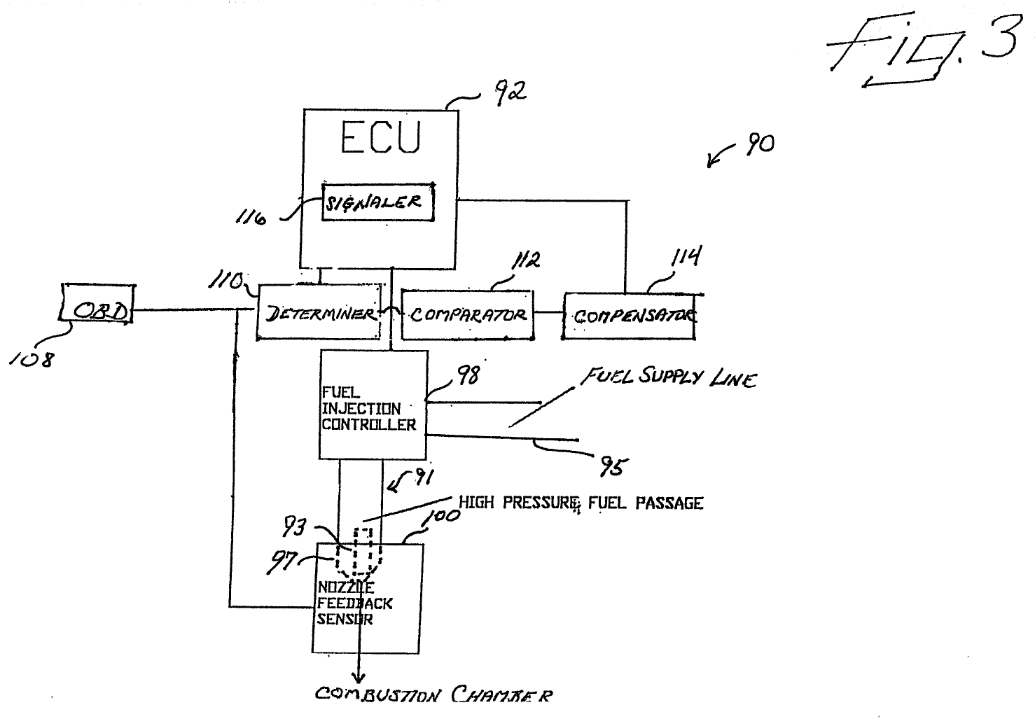

FIG. 3 illustrates a second embodiment of an apparatus 90 according to the present invention. The apparatus 90 controls for variations in a compression ignition engine's fuel injection timing that result from variability in the compressibility and lubricity of fuels used to power the engine. In this second embodiment, the apparatus 90 functions in conjunction with an existing engine control unit 92. The apparatus 90 includes a fuel injection sensor 100 positioned to sense actuation of a fuel injector 91 and to generate a sensed fuel injection signal in response thereto. The apparatus 90 further includes an actual fuel pulse determiner 110 responsive to the sensed fuel injection signal to determine an actual fuel pulse, Aᵢ, the actual fuel pulse being defined as the duration of the time interval that the fuel injector is actuated to inject fuel into the combustion chamber wherein the time interval is at least partially determined by the compressibility and lubricity of the fuel injected.

As illustrated in FIG. 3, the apparatus 90 further includes a fuel pulse comparator 112 that is responsive to the actual fuel pulse determiner 110 and that compares the actual fuel pulse, Aᵢ, to a preselected desired fuel pulse, Dᵢ, again defined as a desired duration for the fuel injector 91 to be actuated to inject fuel into the combustion chamber. The apparatus also includes a fuel pulse compensator 114 that is responsive to the fuel pulse comparator and that computes a fuel pulse compensation factor, k, the compensation factor being defined as the difference between the actual fuel pulse and the desired fuel pulse, Dᵢ−Aᵢ. Because the apparatus 90 operates in conjunction with an existing engine control unit 92, the computed compensation factor can be supplied to the engine control unit 92. In this embodiment as distinct from the previous embodiment, the command signal is conveyed by the existing engine control unit 92 to the fuel injection controller 98 to control fuel injection by the fuel injector 91. The command signal, however, remains a function of the desired fuel pulse and compensation factor so that the engine control unit signals the injection controller 98 to controllably release fuel for a pulse of duration Cᵢ₊₁=Dᵢ+k. Thus, the subsequent actual fuel pulses more closely correspond to the desired fuel pulse.

According to the present invention, variations in fuel injection timing in a compression ignition engine resulting from variability in the compressibility and lubricity of fuels used to power the engine likewise can be controlled by a program stored in a memory unit and adapted to be used by a processor in conjunction with fuel injector 11 and fuel injection controller 18. The program specifically includes means to compute an actual fuel pulse in response to a sensed fuel injection signal, the actual fuel pulse, Aᵢ, being defined as the duration of the time interval that the fuel injector is actuated. The fuel pulse accordingly is a function of the duration of the time interval that the fuel injector is actuated, and the time interval is at least partially determined by the compressibility and lubricity of the fuel powering the engine.

The program further includes means to compare the actual fuel pulse to a preselected desired fuel pulse, Dᵢ, the desired fuel pulse being defined as a desired duration that the fuel injector 11 be actuated (e.g., a valve 13 of the fuel injector to be in an open position). In addition, the program includes means to compute a fuel pulse compensation factor, k, the compensation factor being defined by the difference obtained by subtracting the actual fuel pulse from the desired fuel pulse, Dᵢ−Aᵢ. Further, the program includes means to generate a command signal that is conveyed to a fuel injection controller 18 in communication with the fuel injector 11. According to the claimed invention, the command signal is based on the desired fuel pulse and compensation factor such that the command signal signals the injection controller 18 to controllably release fuel for a pulse of duration Cᵢ₊₁=Dᵢ+k, so that subsequent actual fuel pulses more closely correspond to the desired fuel pulse. Further according to the claimed invention, the stored program preferably is adapted to individually and independently control for variations in fuel injection timing in each cylinder of a multi-cylinder engine.

FIGS. 1-3 also illustrates a method for controlling variations in fuel injection timing resulting from variability in the compressibility and lubricity of fuels used to power a compression ignition engine. The method according to the present invention includes sensing an actual rate at which fuel is injected into at least one cylinder of the engine, Aᵢ. The actual rate of fuel injection sensed, Aᵢ, is compared to a fuel injection parameter Dᵢ, that indicates a desired rate of fuel injection. If the actual rate of fuel injection, Aᵢ, deviates from the desired rate, Dᵢ, the rate of fuel injection is changed so as to inject fuel at the desired rate. The step of sensing the actual rate, Aᵢ, at which fuel is injected includes sensing the duration of the time interval that the valve 13, 53, 93 of a fuel injector 11, 51, 91 is in an open position, where the actual fuel pulse is a function of the time interval, and the time interval is at least partially determined by the compressibility and lubricity of the fuel used to power the engine. The step of changing the rate of fuel injection includes increasing the time interval between subsequent successive injection pulses when the actual time interval between successive fuel pulses is less than a desired time interval, and decreasing the time interval between subsequent successive injection pulses when the time interval between successive fuel pulses is greater than a desired time interval.

FIGS. 1-3 also illustrate a method for controlling variations in fuel injection timing resulting from variability in the compressibility and lubricity of fuels used to power an ignition compression engine by generating successive command signals including a first command signal, Cᵢ, that actuates a corresponding first fuel injection at a first fuel injection rate into a combustion chamber of the engine in response to the first command signal. According to the method, a first injection value having a correlation with the first actual fuel injection rate, Aᵢ, or fuel pulse is determined. For example, the first injection value can be the duration that a fuel injector valve 13, 53, 93 of a fuel injector 11, 51, 91 is in an open position. Alternatively, the first fuel injection rate, for example, can be the fuel pressure at the nozzle 17, 57, 97 of the fuel injector 11, 51, 91. The first injection value, Aᵢ, is compared to a preselected injection parameter, Dᵢ, where the injection parameter corresponds to a desired rate of fuel injection into the combustion chamber. In response to the comparison, a subsequent, second command signal, Cᵢ₊₁, is generated.

This subsequent, second command signal, Cᵢ₊₁, actuates a second fuel injection at a second fuel injection rate into the combustion chamber thereby yielding a second injection value, Aᵢ₊₁, having a correlation with the second fuel injection rate. The subsequent, second command signal, Cᵢ₊₁, is chosen such that the absolute value of the difference between the second injection value and the preselected injection parameter, |Aᵢ₊₁−Dᵢ|, is less than or equal to the absolute value of the first injection value and the desired rate, |Aᵢ−D|, so that |Aᵢ₊₁−Dᵢ|≦|Aᵢ−Dᵢ|. Accordingly, if the first fuel injection rate deviated from the desired rate, the subsequent fuel injection rate then more closely corresponds to the desired rate.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That claimed is:

1. A system for use with a compression ignition engine to control for variations in the engine's fuel injection timing resulting from variability in the compressibility and lubricity of fuels used to power the engine, the system comprising:
a fuel injection controller to control the release of fuel from a fuel supply line in response to a command signal;
a fuel injector positioned to receive the released fuel and having a valve that opens in response to fluid pressure generated by the fuel received to thereby inject the fuel into at least one combustion cylinder of the engine;
a fuel injection sensor positioned to sense when the valve of the fuel injector is in an open position and to generate a sensed signal responsive to the sensed open position;
an engine controller in communication with the fuel injection controller and the fuel injection sensor, the engine controller including:
an actual fuel pulse determiner responsive to the sensed signal to determine an actual fuel pulse, Aᵢ, defined as the duration of the time interval that the valve of the fuel injector is in an open position, the time interval at least partially determined by the compressibility and lubricity of fuel supplied through the fuel supply line,
a fuel pulse comparator responsive to the actual fuel pulse determiner to compare the actual fuel pulse to a preselected desired fuel pulse, Dᵢ, the desired fuel pulse being defined as a desired duration for the fuel injector to be in an open position,
a fuel pulse compensator responsive to the fuel pulse comparator to compute a fuel pulse compensation factor, k, the compensation factor being defined by the difference obtained by subtracting the actual fuel pulse from the desired fuel pulse, Dᵢ−Aᵢ, and
a command signaler responsive to the fuel pulse compensator and being in communication with the fuel injection controller to generate the command signal based on the desired fuel pulse and compensation factor such that the command signal signals the injection controller to controllably release fuel for a pulse of duration Cᵢ₊₁=Dᵢ+k, so that subsequent actual fuel pulses more closely correspond to the desired fuel pulse.

2. A system as defined in claim 1, further comprising an onboard diagnostic indicator in communication with the engine controller to indicate when the system fails to control for variations between the actual fuel pulse and the desired fuel pulse.

3. A system as defined in claim 2, wherein the onboard diagnostic indicator indicates when the fuel injector is inoperative and requires repair.

4. A system as defined in claim 1, wherein the fuel injector includes an injection nozzle having a needle valve and wherein the fuel injection sensor is positioned to sense movement of the needle.

5. A system as defined in claim 1, wherein the fuel injector includes an injection nozzle and wherein the fuel injection sensor is positioned to sense fluid pressure at the nozzle of the fuel injector.

6. A system as defined in claim 1, wherein the fuel injection sensor is a pressure transducer positioned adjacent the fuel injector.

7. A system as defined in claim 1, wherein the fuel injection sensor is a piezoelectric sensor positioned adjacent the fuel injector.

8. A system as defined in claim 1, wherein the system is adapted to individually and independently control for variations in fuel injection timing in each cylinder of a multi-cylinder engine.

9. A system for use with a compression ignition engine to control for variations in the engine's fuel injection timing resulting from variability in the compressibility and lubricity of fuels used to power the engine, the system comprising:
a fuel injection controller to control the release of fuel from a fuel supply line in response to a command signal;
a fuel injector positioned to receive the released fuel and inject the fuel into at least one combustion cylinder of the engine when actuated;
a fuel injection sensor positioned to sense when the fuel injector is actuated and to generate a sensed signal responsive to the sensed open position;
an engine controller in communication with the fuel injection controller and the fuel injection sensor, the engine controller including:
an actual fuel pulse determiner responsive to the sensed signal to determine an actual fuel pulse, Aᵢ, defined as the duration of the time interval that the fuel injector is actuated, the time interval at least partially determined by the compressibility and lubricity of fuel supplied through the fuel supply line,
a fuel pulse comparator responsive to the actual fuel pulse determiner to compare the actual fuel pulse to a preselected desired fuel pulse, Dᵢ, the desired fuel pulse being defined as a desired duration for the fuel injector to be in an open position,
a fuel pulse compensator responsive to the fuel pulse comparator to compute a fuel pulse compensation factor, k, the compensation factor being defined by the difference obtained by subtracting the actual fuel pulse from the desired fuel pulse, Dᵢ−Aᵢ, and
a command signaler responsive to the fuel pulse compensator and being in communication with the fuel injection controller to generate the command signal based on the desired fuel pulse and compensation factor such that the command signal signals the injection controller to controllably release fuel for a pulse of duration Cᵢ₊₁=Dᵢ+k, so that subsequent actual fuel pulses more closely correspond to the desired fuel pulse.

10. A system as defined in claim 9, further comprising an onboard diagnostic indicator in communication with the engine controller to indicate when the system fails to control for deviation between the actual fuel pulse and desired fuel pulse.

11. A system as defined in claim 10, wherein the onboard diagnostic indicator indicates when the fuel injector is inoperative and requires repair.

12. A system as defined in claim 9, wherein the fuel injector includes an injection nozzle having a needle valve and wherein the fuel injection sensor is positioned to sense movement of the needle.

13. A system as defined in claim 9, wherein the fuel injector includes an injection nozzle and wherein the fuel injection sensor is positioned to sense fluid pressure at the nozzle of the fuel injector.

14. A system as defined in claim 9, wherein the fuel injection sensor is a pressure transducer positioned adjacent the fuel injector.

15. A system as defined in claim 9, wherein the fuel injection sensor is a piezoelectric sensor positioned adjacent the fuel injector.

16. A system as defined in claim 9, wherein the system is adapted to individually and independently control for variations in fuel injection timing in each cylinder of a multi-cylinder engine.

17. An apparatus to control for variations in a compression ignition engine's fuel injection timing resulting from variability in the compressibility and lubricity of fuels used to power the engine, the apparatus comprising:
a fuel injection sensor positioned to sense when a fuel injector is actuated to inject fuel into a combustion chamber of the engine and to generate a sensed fuel injection signal in response thereto;
an actual fuel pulse determiner responsive to the sensed fuel injection signal to determine an actual fuel pulse, Aᵢ, defined as the duration of the time interval that the fuel injector is actuated to inject fuel into the combustion chamber, the time interval at least partially determined by the compressibility and lubricity of the fuel injected;
a fuel pulse comparator responsive to the actual fuel pulse determiner to compare the actual fuel pulse to a preselected desired fuel pulse, Dᵢ, the desired fuel pulse being defined as a desired duration for the fuel injector to be actuated to inject fuel into the combustion chamber;
a fuel pulse compensator responsive to the fuel pulse comparator to compute a fuel pulse compensation factor, k, the compensation factor being defined by the difference obtained by subtracting the actual fuel pulse from the desired fuel pulse, Dᵢ−Aᵢ, and
a command signaler responsive to the fuel pulse compensator and being in communication with a fuel injection controller positioned to control fuel injection by the fuel injector in response to a command signal, the command signal being generated by the command signaler based on the desired fuel pulse and compensation factor such that the command signal signals the injection controller to controllably release fuel for a pulse of duration Cᵢ₊₁=Dᵢ+k, so that subsequent actual fuel pulses more closely correspond to the desired fuel pulse.

18. An apparatus as defined in claim 17, further comprising an onboard diagnostic indicator in communication with the fuel injection sensor and adapted to indicate when the apparatus fails to control for variations in fuel injection timing.

19. A apparatus as defined in claim 18, wherein the onboard diagnostic indicator indicates when the fuel injector is inoperative and requires repair.

20. An apparatus as defined in claim 17, wherein the fuel injector includes an injection nozzle having a needle valve responsive to the fuel injection controller and wherein the fuel injection sensor is positioned to sense movement of the needle.

21. An apparatus as defined in claim 17, wherein the fuel injector includes an injection nozzle and wherein the fuel injection sensor is positioned to sense fluid pressure in the nozzle.

22. An apparatus as defined in claim 17, wherein the fuel injection sensor is a pressure transducer positioned adjacent the fuel injector.

23. An apparatus as defined in claim 17, wherein the fuel injection sensor is a piezoelectric sensor positioned adjacent the fuel injector.

24. An apparatus as defined in claim 17, where in the apparatus is adapted to individually and independently control for variations in fuel injection timing in each cylinder of a multi-cylinder engine.

25. An apparatus to control for variations in fuel injection timing in a compression ignition engine resulting from variability in the compressibility and lubricity of fuels used to power the engine, the apparatus comprising:
a fuel injection sensor adapted to communicate with an engine control unit (ECU) and to be positioned to sense fuel injection from a fuel injector into a combustion cylinder of the engine and to generate a sensed fuel injection signal in response thereto; and
a program storable in a memory associated with the ECU, the program including:
means to compute an actual fuel pulse in response to the sensed fuel injection signal, the actual fuel pulse, Aᵢ, defined as the duration of the time interval that the fuel injector is actuated for injecting fuel into the combustion chamber, the time interval at least partially determined by the compressibility and lubricity of the fuel injected;
means to compare the actual fuel pulse to a preselected desired fuel pulse, Dᵢ, the desired fuel pulse being defined as a desired duration for the fuel injector to be in an open position;
means to compute a fuel pulse compensation factor, k, the compensation factor being defined by the difference obtained by subtracting the actual fuel pulse from the desired fuel pulse, Dᵢ−Aᵢ, and means to cause the ECU to generate a command signal that is conveyed to a fuel injection controller in communication with the fuel injector, the command signal being based on the desired fuel pulse and compensation factor such that the command signal signals the injection controller to controllably release fuel for a pulse of duration Cᵢ₊₁=Dᵢ+k, so that subsequent actual fuel pulses more closely correspond to the desired fuel pulse.

26. An apparatus as defined in claim 25, wherein the fuel injection sensor is adapted to sense movement of a needle valve of a fuel injector having an injection nozzle and a needle valve.

27. An apparatus as defined in claim 25, wherein the fuel injection sensor is adapted to sense fluid pressure in a fuel injector having a fuel injection nozzle.

28. An apparatus as defined in claim 25, wherein the fuel injection sensor is a pressure transducer adapted to be positioned adjacent the fuel injector.

29. An apparatus as defined in claim 25, wherein the fuel injection sensor is a piezoelectric sensor adapted to be positioned adjacent the fuel injector.

30. An apparatus as defined in claim 25, where in the apparatus is adapted to individually and independently control for variations in fuel injection timing in each cylinder of a multi-cylinder engine.

31. A program stored in a memory unit and adapted to be used by a processor in conjunction with fuel injector and fuel injection controller to control for variations in fuel injection timing in a compression ignition engine resulting from variability in the compressibility and lubricity of fuels used to power an engine, the program comprising:
means to compute an actual fuel pulse in response to the sensed fuel injection signal, the actual fuel pulse, Aᵢ defined as the duration of the time interval that the valve of the fuel injector is in an open position, the actual fuel pulse being a function of the time interval and the time interval at least partially determined by the compressibility and lubricity of the fuels used to power the engine;
means to compare the actual fuel pulse to a preselected desired fuel pulse, Dᵢ, the desired fuel pulse being defined as a desired duration for the fuel injector to be in an open position;
means to compute a fuel pulse compensation factor, k, the compensation factor being defined by the difference obtained by subtracting the actual fuel pulse from the desired fuel pulse, Di−Aᵢ, and
means to generate a command signal that is conveyed to a fuel injection controller in communication with the fuel injector, the command signal being based on the desired fuel pulse and compensation factor such that the command signal signals the injection controller to controllably release fuel for a pulse of duration Cᵢ₊₁=Dᵢ+k, so that subsequent actual fuel pulses more closely correspond to the desired fuel pulse.

32. A stored program as defined in claim 31, wherein the program is adapted to individually and independently control for variations in fuel injection timing in each cylinder of a multi-cylinder engine.

33. A method for controlling variations in fuel injection timing resulting from variability in the compressibility and lubricity of fuel used to power a compression ignition engine, the method comprising:
sensing the actual rate at which fuel is injected into at least one cylinder of the engine;
comparing the actual rate of fuel injection sensed with a fuel injection parameter indicating the desired rate of fuel injection; and
changing the rate of fuel injection to thereby inject fuel at the desired rate.

34. A method as defined in claim 33, wherein sensing the actual rate at which fuel is injected comprises sensing the duration of the time interval that the valve of the fuel injector is in an open position, the actual fuel pulse being a function of the time interval, the time interval at least partially determined by the compressibility and lubricity of the fuel used to power the engine.

35. A method as defined in claim 33, wherein changing the rate of fuel injection comprises increasing the time interval between subsequent successive injection pulses when the actual time interval between successive fuel pulses is less than a desired time interval, and decreasing the time interval between subsequent successive injection pulses when the time interval between successive fuel pulses is greater than a desired time interval.

36. A method for controlling variations in fuel injection timing resulting from variability in the compressibility and lubricity of fuels used to power an ignition compression engine, the method comprising:
generating a first command signal, Cᵢ;
actuating a first fuel injection at a first fuel injection rate into a combustion chamber of the engine in response to the first command signal;
determining a first injection value, Aᵢ, having a correlation with the first fuel injection rate;
comparing the first injection value, Aᵢ, to a preselected injection parameter, Dᵢ, corresponding to a desired rate of fuel injection into the combustion chamber;
generating a second command signal, Cᵢ₊₁, in response to the comparison between the first injection value, Aᵢ, and the injection parameter, Dᵢ;
actuating a second fuel injection at a second fuel injection rate into the combustion chamber in response to the second command signal, Cᵢ₊₁, yielding a second injection value, Aᵢ₊₁, having a correlation with the second fuel injection rate such that the absolute value of the difference between the second injection value and the preselected injection parameter, |Aᵢ₊₁−Dᵢ|, is less than or equal to the absolute value of the first injection value and the desired rate, |Aᵢ−Dᵢ, so that |Aᵢ₊₁−Dᵢ51 ≦|Aᵢ−Dᵢ|.

37. A method as defined in claim 36, wherein the first and second injection values are each functions of a time interval during which the valve of a fuel injector is in an open position.

38. A method as defined in claim 36, wherein the first and second injection values are each functions of fluid pressure of fuel being released by a fuel injector into the combustion chamber.
